(19) United States
(12) Patent Application Publication
(10) Pub. No.: US 2024/0202024 A1
(43) Pub. Date: Jun. 20, 2024

(54) THREAD PROCESSING METHODS, SCHEDULING COMPONENT, MONITORING COMPONENT, SERVER, AND STORAGE MEDIUM

(71) Applicant: Alibaba Damo (Hangzhou) Technology Co., Ltd., Hangzhou City (CN)

(72) Inventors: Meng Wang, Beijing (CN); Pengyu Zhang, Bellevue, WA (US); Yunshan Jia, Beijing (CN); Biyi Li, Beijing (CN)

(73) Assignee: Alibaba Damo (Hangzhou) Technology Co., Ltd., Hangzhou City (CN)

(21) Appl. No.: 18/171,257

(22) Filed: Feb. 17, 2023

(30) Foreign Application Priority Data
Dec. 14, 2022 (CN) 202211599968.1

(51) Int. Cl. G06F 9/48

(52) U.S. Cl. CPC G06F 9/4881

(57) ABSTRACT

Thread processing methods, a scheduling component, a monitoring component, a server, and a storage medium are provided. The method includes: determining, by a scheduling component in the server, a duration for which a worker thread is in a blocked state, determining a workload index parameter of the worker thread according to the duration, and further generating a resource scheduling strategy according to the workload index parameter. The kernel of the server may reallocate the computing resource of the server by using the resource scheduling strategy.

### CROSS-REFERENCE TO RELATED APPLICATIONS

This application claims priority to Chinese patent application, No. 202211599968.1, entitled “Thread Processing Methods, Scheduling Component, Monitoring Component, Server, and Storage Medium”, filed with the Chinese Patent Office on Dec. 14, 2022, which is hereby incorporated by reference in its entirety.

### TECHNICAL FIELD

The present disclosure relates to the field of communication technology, and in particular to thread processing methods, a scheduling component, a monitoring component, a server, and a storage medium.

### BACKGROUND

With the development of the Network Function Virtualization (NFV for short), more and more function instances may implement their corresponding functions through software programs deployed in servers, thereby reducing hardware costs and realizing flexible deployment. More specifically, a worker thread in a server uses computing resources of the server to perform various tasks generated by a function instance, to achieve a function corresponding to the function instance. Here, a function instance may be a base station in an access network or various functional network elements of a core network deployed in a server in the form of a software program, or other third-party application programs related to the functions provided by the function instance.

### SUMMARY

In view of this, embodiments of the present disclosure provide thread processing methods, a scheduling component, a monitoring component, a server, and a storage medium, to reasonably perform the computing resource scheduling to improve the utilization of computing resources.

In the first aspect, an embodiment of the present disclosure provides a thread processing method that is applied to a scheduling component in a server. The method includes: determining a duration for which a worker thread in the server is in a blocked state, here, the worker thread is in the blocked state after a previous task generated by a function instance in the server is completed and before a next task generated by the function instance is acquired; determining a workload index parameter of the worker thread according to the duration of the worker thread in the blocked state; and generating a resource scheduling strategy according to the workload index parameter, such that a kernel of the server reallocates a computing resource of the server according to the scheduling strategy.

In the second aspect, an embodiment of the present disclosure provides a thread processing method that is applied to a cloud server in which a 5G private network runs. The method includes: determining a duration for which a worker thread in the cloud server is in a blocked state, here, the worker thread is in the blocked state after a previous task generated by a function instance in the server is completed and before a next task generated by the function instance is acquired; determining a workload index parameter of the worker thread according to the duration of the worker thread in the blocked state, here, the function instance includes a functional network element in the 5G private network; and generating a resource scheduling strategy according to the workload index parameter, such that a kernel of the server reallocates a computing resource of the server according to the scheduling strategy.

In the third aspect, an embodiment of the present disclosure provides a thread processing method that is applied to a monitoring component in a server. The method includes: determining a duration for which a worker thread in the server is in blocked state when a working cycle of the monitoring component is reached, here, the worker thread is in the blocked state after a previous task generated by a function instance in the server is completed and before a next task generated by the function instance is acquired; and determining a workload index parameter of the worker thread according to the duration of the worker thread in the blocked state, herein is a length of the working cycle on an order of magnitude of microseconds.

In the fourth aspect, an embodiment of the present disclosure provides a scheduling component that runs on a server. The scheduling component includes a duration monitoring sub-component, an index monitoring sub-component, and a strategy generation sub-component.

The duration monitoring sub-component is configured for determining a duration for which a worker thread in the server is in a blocked state, here, the worker thread is in the blocked state after a previous task generated by a function instance in the server is completed and before a next task generated by the function instance is acquired.

The index monitoring sub-component is configured for determining a workload index parameter of the worker thread according to the duration of the worker thread in the blocked state.

The strategy generation sub-component is configured for generating a resource scheduling strategy according to the workload index parameter, such that a kernel of the server reallocates a computing resource of the server according to the scheduling strategy.

In the fifth aspect, an embodiment of the present disclosure provides a monitoring component that runs on a server. The monitoring component includes a duration monitoring sub-component and an index monitoring sub-component.

The duration monitoring sub-component is configured for determining a duration for which a worker thread in the server is in a blocked state when a working cycle of the monitoring component is reached, here, the worker thread is in the blocked state after a previous task generated by a function instance in the server is completed and before a next task generated by the function instance is acquired.

The index monitoring sub-component is configured for determining a workload index parameter of the worker thread according to the duration of the worker thread in the blocked state, herein is a length of the working cycle on an order of magnitude of microseconds.

In the sixth aspect, an embodiment of the present disclosure provides a server. The server includes a scheduling component, a kernel, a function instance, and a computing resource.

The scheduling component is configured for: determining a duration for which a worker thread in the server is in a blocked state, here, the worker thread is in the blocked state after a previous task generated by the function instance in the server is completed and before a next task generated by the function instance is acquired; determining a workload index parameter of the worker thread according to the duration of the worker thread in the blocked state; and generating a resource scheduling strategy according to the workload index parameter.

The kernel is configured for reallocating the computing resource of the server according to the resource scheduling strategy.

In the seventh aspect, an embodiment of the present disclosure provides a non-transitory machine-readable storage medium. The non-transitory machine-readable storage medium have executable codes stored thereon. The executable codes, when executed by a processor of an electronic device, enable the processor to at least implement any one of the thread processing methods in the first to third aspects.

### BRIEF DESCRIPTION OF THE DRAWINGS

To describe technical solutions of embodiments of the present disclosure or of the prior art more clearly, the accompanying drawings to be used in the description of embodiments or in the description of the prior art will be described briefly below. Evidently, the accompanying drawings described below are drawings of some embodiments of the present disclosure. Those of ordinary skill in the art may obtain other drawings based on these accompanying drawings without creative efforts.

FIG. 1 is a flowchart of a thread processing method provided by an embodiment of the present disclosure.

FIG. 2 is a schematic diagram of a workflow of a worker thread provided by an embodiment of the present disclosure.

FIG. 3 is a flowchart of another thread processing method provided by an embodiment of the present disclosure.

FIG. 4 is a flowchart of a yet another thread processing method provided by an embodiment of the present disclosure.

FIG. 5a is a flowchart of determining a workload index parameter of a worker thread provided by an embodiment of the present disclosure.

FIG. 5b is another flowchart of determining a workload index parameter of a worker thread provided by an embodiment of the present disclosure.

FIG. 5c is a yet another flowchart of determining a workload index parameter of a worker thread provided by an embodiment of the present disclosure.

FIG. 6 is a flowchart of a yet another thread processing method provided by an embodiment of the present disclosure.

FIG. 7 is a schematic structural diagram of a scheduling component provided by an embodiment of the present disclosure.

FIG. 8 is a schematic structural diagram of a monitoring component provided by an embodiment of the present disclosure.

FIG. 9 is a schematic structural diagram of a server provided by an embodiment of the present disclosure.

FIG. 10 is a schematic structural diagram of another server provided by an embodiment of the present disclosure.

FIG. 0.11 is a schematic diagram of applying a thread processing method and a scheduling component in a 5G private network provided by an embodiment of the present disclosure.

FIG. 12 is a schematic structural diagram of an electronic device provided by an embodiment of the present application.

FIG. 13 is a schematic structural diagram of another electronic device provided by an embodiment of the present application.

FIG. 14 is a schematic structural diagram of a yet another electronic device provided by an embodiment of the present application.

### DETAILED DESCRIPTION

In order to make purposes, technical solutions, and advantages of embodiments of the present disclosure clearer, the technical solutions in the embodiments of the present disclosure will be described clearly and comprehensively below in conjunction with the accompanying drawings of the embodiments of the present disclosure. Obviously, the embodiments described are a part of, but not all, the embodiments of the present disclosure. All other embodiments obtained by those of ordinary skill in the art based on the embodiments of the present disclosure without creative efforts fall within the scope of protection of the present disclosure.

Terms used in the embodiments of the present disclosure are only for the purpose of describing a specific embodiment, and are not intended to limit the present disclosure. Singular forms, “a,” “said,” and “the,” used in the embodiments of the present disclosure and in the appended claims are also intended to include plural forms, unless the singular forms clearly indicate other meanings in the context. “A plurality of” generally includes at least two, but does not exclude the inclusion of at least one.

It should be understood that the term “and/or” used herein is only an association relationship describing association objects, which indicates that there may be three kinds of relationships. For example, A and/or B may indicate the following three situations: there is A alone, there are A and B at the same time, and there is B alone. In addition, the character “/” herein generally indicates that the objects associated with each other in the preceding and following contexts have an “or” relationship.

Depending on the context, the words “in the case where” and “if” as used herein may be interpreted as “when,” “while,” “in response to determining,” or “in response to identifying.” Similarly, depending on the context, the phrase “if determining (the stated condition or event)” or “if identifying (the stated condition or event)” may be interpreted as “when determining (the stated condition or event),” “in response to determining (the stated condition or event),” “when identifying (the stated condition or event),” or “in response to identifying (the stated condition or event).”

It should also be noted that terms “comprise,” “include,” or any other variants thereof are intended to cover a non-exclusive inclusion, such that commodities or systems including a series of elements, include not only those elements that have been listed, but also other elements that are not specifically listed, or elements intrinsic to these commodities or systems. Without further limitations, elements limited by the wording “include(s) a/an . . . ” or “comprise(s) a/an . . . ” do not exclude additional identical elements in the commodities or systems including the listed elements.

Some embodiments of the present disclosure will be described in detail below in combination with the accompanying drawings. The following embodiments and features of the embodiments may be combined with each other, in the case where there is no conflict between various embodiments. In addition, the timing-sequence of steps in the following method embodiments is only an example and is not strictly limited.

However, in the existing technology, since the isolation-allocation of computing resources of a server greatly reduces the utilization of the computing resources, it is often necessary to schedule the computing resources of the server to improve the utilization of the computing resources, and the frequency of resource scheduling also directly affects the scheduling effect of computing resources.

With the development of the 5th generation mobile communication technology (called as 5G for short), there are more and more application scenarios of 5G communication networks. For example, users may be provided with multiple services, such as automatic driving, live video. In combination with the background again, function instances may be, in the form of software programs, deployed in the server. Therefore, 5G communication networks may be created by using function instances in the form of software programs.

Optionally, in a more specific application scenario of the 5G communication network, the network may also be, as a 5G private network, deployed in a certain industrial park or a certain industrial assembly line, to perform video monitoring on the park or assembly line, etc. Each of function instances in the 5G private network may therefore be, in the form of the software programs, deployed in a cloud server.

In this scenario, each of the following elements may be considered as the function instances: the next generation node base station (gNB) included in an access network in the 5G private network, various control plane function (CPF) network elements included in a core network in the 5G private network, and various user plane function (UPF) network elements included in the core network in the 5G private network. The 5G communication network may therefore be created by deploying these function instances in the form of software programs in a server. Here, the CPF network elements may be any type of control surface functional network elements in the general 5G core network, such as access and mobility management function (AMF) network elements, session management function (SMF) network elements. The specific content of the network elements will not be described in detail herein.

In addition, when the server, as a 5G communication network operation carrier, works normally, various function instances in the server may continuously generate tasks and add the tasks into corresponding task queues. The server may also create a worker thread and allocate computing resources of the server to the worker thread, so that the worker thread may acquire and execute the tasks in the task queues. Here, the worker thread may also be called as a working thread. In addition, the server may allocate the computing resources to worker threads in an isolation-deployment manner, that is, a worker thread may exclusively occupy the computing resources allocated to the worker thread. Here, the computing resources allocated to the worker threads may specifically include CPU resources, memory resources, hard disk resources, and the like. Optionally, the server may be configured with a multi-core CPU, and each of the worker threads may be allocated to computing resources of a certain CPU kernel.

Optionally, the server may also be provided with third-party application programs associated with functions provided by the above function instances. For a 5G private network deployed in a certain industrial park or a certain industrial assembly line, the third-party application programs associated with the 5G private network may include various video acquisition software, such as camera software, augmented reality (AR) software, virtual reality (VR) software. Optionally, the third-party application programs may also include operation and maintenance software configured for detecting and maintaining the normal operation of the above video acquisition software. These third-party application programs also generate tasks in the operation process. Thus, the server may also create corresponding work threads and allocate computing resources of the server.

In practice, when a workload of a worker thread is saturated, that is, the worker thread may continuously acquire and execute tasks, and because the server usually uses asynchronous scheduling mechanism to allocate tasks to the worker thread, the worker thread cannot acquire tasks until the worker thread waits for a certain time. During this waiting period, computing resources allocated to the worker thread are in an idle state and this part of computing resources are wasted, resulting in a low utilization of computing resources of the server. In another case, when the workload of the worker thread is not saturated, and because the computing resources are isolation-deployed, these computing resources exclusively occupied by the worker thread are also in the idle state, the utilization of the computing resources is therefore still low.

Thus, in order to improve the utilization of the computing resources of the server, it is necessary to perform resource scheduling. In addition, in order to further improve the utilization of the computing resources, a resource scheduling cycle should also be considered when the resource scheduling is performed. Specifically, use of a larger scheduling cycle cannot schedule idle computing resources to other worker threads in time, that is, there is no significant effect of improving the utilization rate of the resources. Use of a smaller scheduling cycle will affect the work stability of a worker thread.

In addition, in the server deployed with the 5G communication network, most of tasks processed by the worker threads are tasks generated by various functional network elements in a core network or generated by a gNB in an access network. These tasks have high requirements on the timing-sequence property of execution and the timeliness of execution. The destruction of the timing-sequence property of execution will affect the operation of a 5G communication network and even cause network paralysis. Thus, in the process of resource scheduling, the normal execution of tasks cannot be disrupted.

Based on the actual situation described above, the thread processing methods provided in the following embodiments of the present disclosure may be used to perform resource scheduling at an appropriate scheduling cycle while ensuring the timing-sequence execution of tasks.

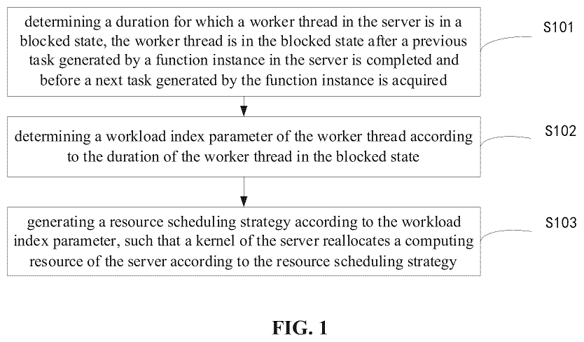

FIG. 1 is a flowchart of a thread processing method provided by an embodiment of the present disclosure. The thread processing method provided by an embodiment of the present disclosure may be performed by a scheduling component deployed in a server. Here, the scheduling component may operate when an operating system of the server is in a user mode.

As shown in FIG. 1, the method may include the following steps S101 to S103.

At the step S101, a duration for which a worker thread in the server is in a blocked state is determined, here, the worker thread is in the blocked state after a previous task generated by a function instance in the server is completed and before a next task generated by the function instance is acquired.

According to the above description, function instances deployed in a server may be gNBs, functional network elements of a core network, or various functional network elements of other 4G networks, etc. The tasks generated by these function instances may be cached into at least one task queue corresponding to the function instances. At the same time, the server may also create a worker thread, such that the created worker thread acquires a task from the at least one task queue corresponding to the function instances, and executes the task. In addition, a worker thread that normally works may continuously switch between a running state and a blocked state. The scheduling component in the server may therefore acquire a duration for which the worker thread in the server is in the blocked state. In combination with a workflow of a worker thread and a working state of the worker thread, a blocked state of the worker thread and a duration of the blocked state may be described below.

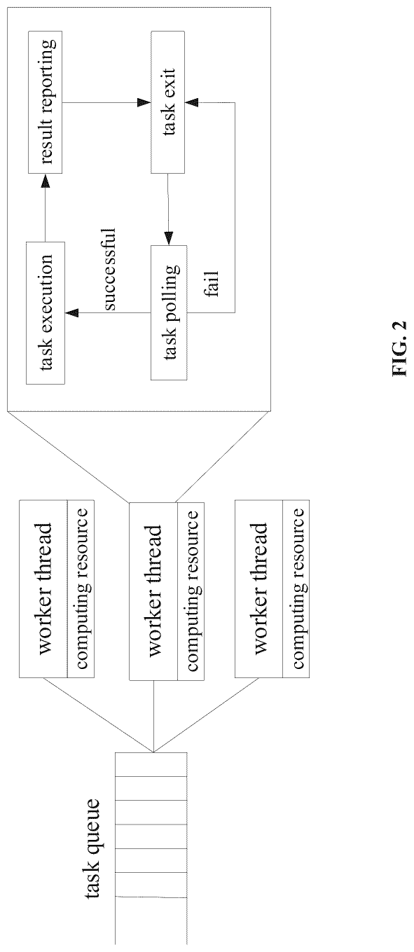

The workflow of a worker thread may specifically include four stages: task polling—task execution—result reporting—task exit. The worker thread cycles continuously the above four stages until the worker thread is suspended, that is, the server recycles the computing resources allocated to the worker thread. The above process may also be understood with reference to FIG. 2.

In the task polling stage, in the case where the polling is successful, the worker thread may acquire a task from the task queue. Then, the worker thread enters the task execution stage and the result reporting stage successively. In the task execution stage and the result reporting stage, the worker thread is respectively configured for executing the task acquired from the task queue and reporting the execution result. In all the above stages, the worker thread is in a running state, and the worker thread, in the user mode of the operating system of the server, realizes the task acquisition, the task execution, and the execution result reporting. After the execution result is reported, the worker thread may enter the task exit stage. In the case where the polling fails, the worker thread does not acquire any task from the task queue, and then the worker thread directly enters the task exit stage. In the task exit stage, the worker thread is in a state in which the worker thread has just executed a previous task generated by the function instance and has not yet acquired a next task generated by the function instance. At this time, the worker thread is in the blocked state. In addition, the worker thread will remain in the blocked state until the worker thread acquires a next task. Optionally, the duration of the blocked state may be on an order of microseconds.

At the step S102, a workload index parameter of the worker thread is determined according to the duration of the worker thread in the blocked state.

Since the duration of the blocked state is the time period during which the worker thread executes a previous task and has not acquired a next task, the length of the duration may reflect the workload size of the worker thread. As an optional manner, the scheduling component may determine the length of the duration as a workload index parameter of the worker thread, and may generate a resource scheduling strategy according to the index parameter. Here, the scheduling strategy may include creating a worker thread and recycling a worker thread.

Specifically, in the case where the length of the duration exceeds a preset time length, it indicates that the worker thread needs to wait for a long time to acquire the next task after executing the previous task. This indicates that the workload of the worker thread is not saturated, and the workload of the worker thread is relatively small. The resource scheduling strategy generated by the scheduling component is to recycle the worker thread, that is, to recycle the computing resources allocated to the worker thread, such that the worker thread is suspended. In the case where the length of the duration does not exceed the preset time length, it indicates that the workload of the worker thread is saturated, and the workload of the worker thread is relatively large. The resource scheduling strategy generated by the scheduling component is to newly create a worker thread, and allocate the computing resources of the server to the newly created worker thread.

It is easy to understand that a worker thread may be, during the process of continuous execution of a plurality of tasks, in the blocked states for many times, that is, the worker thread will enter the blocked state after the worker thread executes one task every time. In order to further ensure that the determined workload index parameter can accurately reflect the workload size of the worker thread, in another optional manner, the scheduling component may also, when the worker thread is continuously in blocked states for many times, monitor a duration of each of the blocked states. The scheduling component may determine respective lengths of multiple durations as the workload index parameters of the worker thread. In the case where the lengths of multiple consecutive durations exceeds the preset time length, it indicates that the workload of the worker thread is relatively small, and the generated resource scheduling strategy is to recycle the thread. In the case where the lengths of multiple consecutive durations do not exceed the preset time length, the resource scheduling strategy generated by the scheduling component is to create a thread.

At the step S103, a resource scheduling strategy is generated according to the workload index parameter, such that a kernel of the server reallocates a computing resource of the server according to the scheduling strategy.

Finally, the scheduling component may also send the resource scheduling strategy to a kernel of the server, such that the kernel performs the resource scheduling strategy if the operating system of the server is in a kernel mode.

In this embodiment, the scheduling component in the server may determine a duration for which a worker thread is in a blocked state, determine a workload index parameter of the worker thread according to the duration, and further generate a resource scheduling strategy according to the workload index parameter, such that a kernel of the server reallocates computing resources of the server by using the resource scheduling strategy.

In the above process, each time the worker thread executes a task, the scheduling component may compute a workload index parameter of the worker thread and further schedule the computing resources of the server. That is, the computing resource scheduling cycle is shortened to the same order of magnitude as the task execution time length. Timely scheduling of the computing resources may also improve the utilization of the computing resources of the server. In addition, the duration of the blocked state is an intermittent period during which the worker thread executes tasks continuously, such that the resource scheduling is performed between two tasks, thereby not affecting the normal execution of tasks by the worker thread.

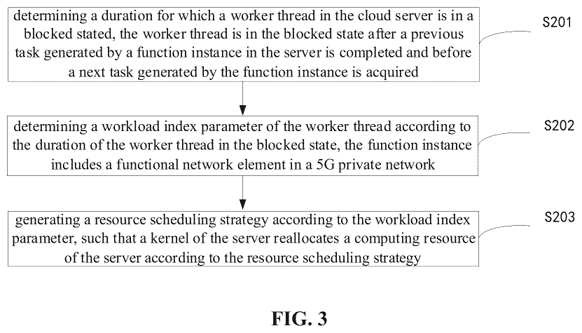

According to the above description, it can be known that the 5G communication network may specifically be a 5G private network running in a cloud server. The cloud server may also perform the method in the embodiment shown in FIG. 1, to realize the resource scheduling. FIG. 3 is a flowchart of another thread processing method provided by an embodiment of the present disclosure. The thread processing method provided by an embodiment of the present disclosure may be performed by a cloud server. As shown in FIG. 3, the method may include the following steps S201-S203.

At the step S201, a duration for which a worker thread in the cloud server is in a blocked stated is determined, here, the worker thread is in the blocked state after a previous task generated by a function instance in the server is completed and before a next task generated by the function instance is acquired.

At the step S202, a workload index parameter of the worker thread is determined according to the duration of the worker thread in the blocked state, here, the function instance includes a functional network element in a 5G private network.

At the step S203, a resource scheduling strategy is generated according to the workload index parameter, such that a kernel of the server reallocates a computing resource of the server according to the scheduling strategy.

The above method may specifically be performed by a scheduling component deployed in the cloud server. In this embodiment, the specific implementation process of each of the steps, the content not described in detail, and the technical effect that can be achieved may all refer to the relevant description in above embodiments, which will not be repeated herein.

It should be noted that in the 5G private network, for the function instance, such as the gNB, the functional network element in a core network, the duration for which the worker thread is in the blocked state is usually on an order of microseconds. Thus, the scheduling cycle, that is, a working cycle of the scheduling component, of the computing resource in the above embodiment is also in microseconds. In addition, the number of tasks generated by the gNB and the functional network element is often in burst. Such burst may also be on an order of milliseconds or microseconds. At this time, the above thread processing method in microseconds can also cope with the task burst in microseconds.

In addition, in the above embodiment, each time after the worker thread executes a task, that is, each time a duration is generated, the resource scheduling is performed. However, the execution time of each task is different, for example, it can be a few microseconds or more than ten microseconds, which results in unfixed scheduling cycles of resources. In order to enable the scheduling component to more timely determine whether the worker thread is in a blocked state, and to perform the computing resource scheduling in a timely manner, the working cycle of the scheduling component may also be set smaller. For example, the working cycle is 1 microsecond. That is, the scheduling component executes, every 1 microsecond, a determination on whether the worker thread is in a blocked state.

It should also be noted that the commonly used workload index parameter is a queue length of the task queue, but the index parameter needs to be acquired by modifying the underlying codes of the function instance. Thus, the manner of acquiring the index parameter is complex. In addition, considering that the scheduling component and the function instance come from different developers, it is more difficult to modify the low-level codes of the function instance due to the permission. Therefore, it is more difficult to acquire the index parameter. Compared with taking the queue length of the task queue as the index parameter, the duration of the worker thread in the blocked state is taken as the workload index parameter to generate the resource scheduling strategy in the above embodiment. The index parameter, the duration of the worker thread in the blocked state may be acquired without modifying the underlying codes of the function instance, that is, it is easier to acquire the index parameter.

In the embodiments shown in FIG. 1 and FIG. 3, after the worker thread executes the task and reports the execution result, the worker thread performs the task exit stage. Optionally, the worker thread may enter the task exit stage by executing the delay function provided in the scheduling component. T In response to the execution of the delay function, the scheduling component may record a start time and an end time at which the delay function is executed. A time period composed by the start time point and the end time point at which the delay function is executed is the duration for which the worker thread is in a blocked state. Optionally, the delay function may be, for example, a sleep function, a sem-wait function, and the like.

It should be noted that, in practice, the function instance in the form of software programs may also be provided with a delay function. Thus, after a worker thread reports an execution result, the worker thread may also execute the delay function provided in the function instance. However, because the scheduling component and the function instance operating in the server often come from different developers, considering the permission issue, in the case where the low-level codes of the function instance cannot be modified, the scheduling component cannot know the start time the end time that the function instance executes the delay function. In order to enable the scheduling component to know the start time and the end time at which the delay function is executed, the scheduling component may also be provided with the delay function, and the delay function in the scheduling component may be actively executed by using a redirection mechanism, after the worker thread reports the execution result.

By applying the embodiments shown in FIG. 1 and FIG. 3 above, a microseconds-level scheduling for computing resources may be implemented, and the scheduling component performs, after the scheduling component acquires the workload index parameter of the worker thread, the resource scheduling according to the index parameter, a computing cycle of the workload index parameter is therefore also on an order of microseconds.

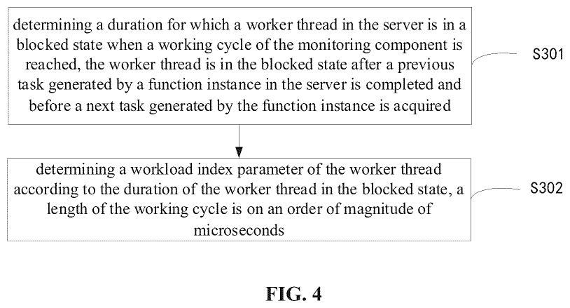

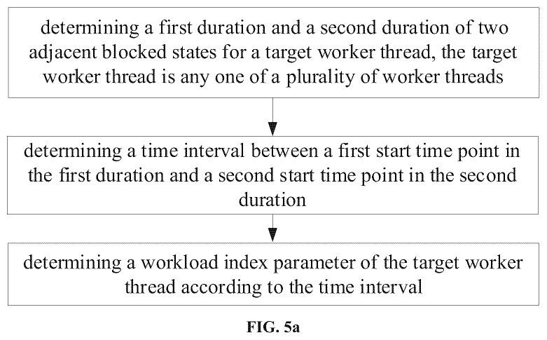

FIG. 4 is a flowchart of a still thread processing method provided by an embodiment of the present disclosure. The thread processing method provided by the embodiment of the present disclosure is in essence a workload index parameter monitoring method. The method may be performed by a monitoring component in a server. As shown in FIG. 4, the method may include the following steps S301-S302.

At the step S301, a duration for which a worker thread in the server is in a blocked state is determined when a working cycle of the monitoring component is reached, here, the worker thread is in the blocked state after a previous task generated by a function instance in the server is completed and before a next task generated by the function instance is acquired.

At the step S302, a workload index parameter of the worker thread is determined according to the duration of the worker thread in the blocked state, herein is a length of the working cycle on an order of magnitude of microseconds.

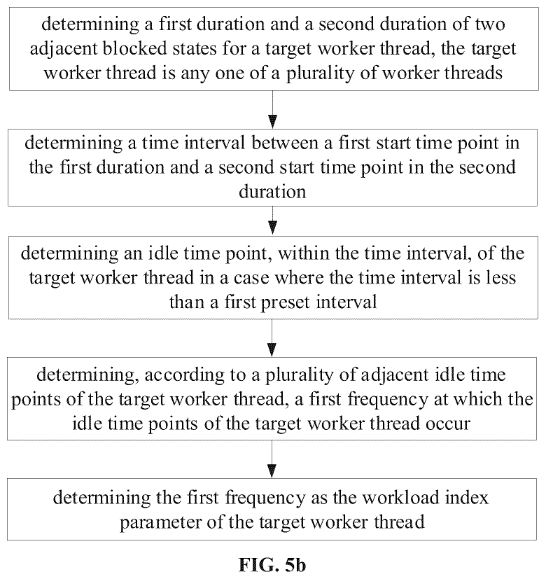

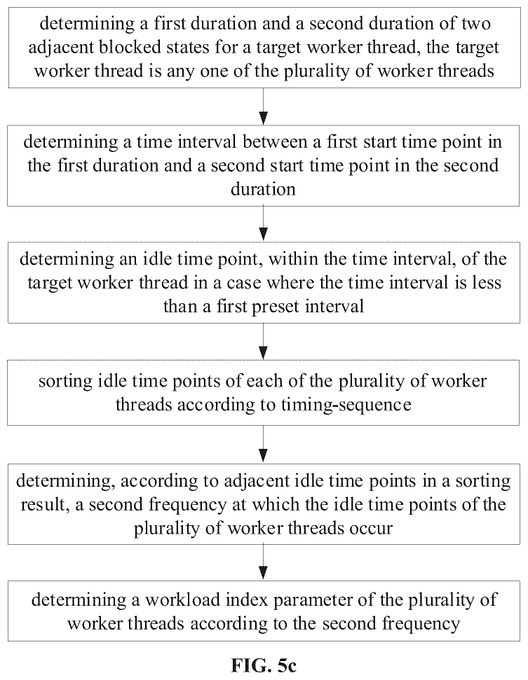

When the working cycle of a monitoring component is reached, the monitoring component starts to determine the duration of the worker thread in a blocked state, and to determine the workload index parameter of the worker thread according to the duration. The specific determination processes of the duration and the workload index parameter may refer to the relevant description in the embodiment shown in FIG. 1 above, which will not be repeated herein. Optionally, the specific determination process of the workload index parameter may also refer to the embodiments shown in FIGS. 5a-5c below.

Herein, the length of the working cycle is in microseconds. According to the above description, optionally, the working cycle of the monitoring component may be 1 microsecond or a few microseconds. The monitoring component may be included in the scheduling component.

In this embodiment, after the monitoring component in the server reaches the working cycle of the monitoring component, the monitoring component may determine the duration of the worker thread in a blocked state, and may determine the workload index parameter of the worker thread according to the duration. In the above process, because the working cycle of the monitoring component is on an order of microseconds and the time length of completely executing, by the worker thread, one task is also on an order of microseconds, the process of computing, by the monitoring component, the workload index parameter of the worker thread is also on an order of microseconds. Thus, a workload monitoring cycle of the worker thread is shortened, that is, the working state of the workload can be monitored in a much timely manner. In addition, the content that is not described in detail and the effect that can be achieved, in this embodiment, may all refer to the relevant description in the above various embodiments, which will not be repeated herein.

According to the above description, the task generated by any one function instance in the server may be executed by at least one worker thread in the server.

In a simple situation, the task generated by one function instance may be executed by one worker thread in the server. At this time, according to the description in the embodiments shown in FIG. 1 and FIG. 3, the scheduling component may first acquire the workload index parameter of the worker thread, and then generate a corresponding resource scheduling strategy according to the workload index parameter, such that the kernel of the server performs the resource scheduling strategy. In this situation, the workload index parameter of the worker thread may be at least one duration corresponding to the worker thread.

In another complex situation, the task generated by one function instance may be executed by a plurality of worker threads in the server. At this time, optionally, the scheduling component may determine, according to a workload index parameter of each of worker threads corresponding to the function instance, whether to perform the computing resource scheduling. That is, the resource scheduling is performed on the basis of a workload of one worker thread. Optionally, the scheduling component may also first determine a general workload index parameter of multiple worker threads corresponding to the function instance, according to the workload index parameter of each of the worker threads. And then, the scheduling component may determine whether to perform the resource scheduling according to the general workload index parameter. That is, the resource scheduling is performed on the basis of workloads of all worker threads corresponding to one function instance.

In the case where the scheduling component may determine, according to the workload index parameter of each of worker threads, whether to perform the computing resource scheduling, the scheduling may still be performed in the manners shown in the embodiments in FIG. 1 and FIG. 3. In this situation, the workload index parameter of each of the worker threads may be at least one duration corresponding to the worker thread.

In the case where the scheduling component may determine, according to the workload index parameter of each of worker threads, whether to perform the computing resource scheduling, in addition to the manners shown in FIG. 1 and FIG. 3, the workload index parameter may optionally be determined according to the following manner. The following manner may also be understood in combination with the flowchart shown in FIG. 5a.

For any one worker thread, that is, a target worker thread, of a plurality of worker threads, the scheduling component first acquires durations of two adjacent blocked states of a target worker thread. One of the two durations may be formed by a first start time point and a first end time point, and the other of the two durations may be formed by a second start time point and a second end time point. The scheduling component may further determine a time interval between the first start time point and the second start time point, and directly determine the time interval as the workload index parameter of the target worker thread. However, contrary to the duration in the embodiment shown in FIG. 1, the longer the time interval is, the more the time, that the target worker thread takes to execute the task, is, and the larger the workload of the target worker thread is. The shorter the time interval is, and the smaller the workload of the target worker thread is.

Further, the process of performing the computing resource scheduling by using the time interval as the workload index parameter, is as follows.

In the case where the time interval is greater than the first preset interval, it indicates that the workload of the target worker thread is large, and the scheduling strategy generated by the scheduling component is to create a worker thread. The newly created worker thread and the target worker thread jointly execute the task generated by the same function instance, thereby reducing the workload of the target worker thread. Optionally, the first preset interval may be a preset number of machine cycles of the server. The preset number of machine cycles may be considered as a time limit, such as 2500 CPU cycles.

In the case where the time interval is smaller than the first preset interval, it indicates that the workload of the target worker thread is small, and the scheduling strategy generated by the scheduling component is to recycle the computing resource allocated to the target worker thread. The recycled computing resources may be scheduled to a further worker thread, in the server, with large workload. The function instance corresponding to the further worker thread may be the same as or different from the function instance corresponding to the target worker thread whose computing resources are recycled. The recycled computing resources may also be allocated by the server to a worker thread that is newly created for a further function instance.

In practice, after the scheduling component generates a resource scheduling strategy, the strategy is immediately sent to the kernel of the server and is performed by the kernel, to achieve the resource scheduling in microseconds. In addition, in the case where the resource scheduling strategy is to recycle the computing resource of the worker thread, the kernel may perform the resource scheduling strategy if the target worker thread is in the blocked state, to ensure that the resource scheduling is realized while the task execution is uninterrupted.

Optionally, in order to further ensure that the determined workload index parameter can accurately reflect the workload size of the worker thread, the scheduling component may also determine the workload index parameter of the target worker thread in the following manner. The following manner may also be understood in combination with the flowchart shown in FIG. 5b.

The scheduling component may first acquire a time interval between the two first start time points in the target worker thread in the manner shown in FIG. 5a. In the case where the time interval is less than the first preset interval, it indicates that the time interval between two blocked states of the target worker thread is relatively small. Therefore, the scheduling component may determine a time point within the time interval, and take the time point as an idle time point of the target worker thread. The target worker thread has a small workload at the idle time point. Because the target worker thread will be in the blocked state for many times, the scheduling component may acquire a plurality of durations. Thus, the scheduling component may also compute, according to the above manner, a plurality of idle time points of the target worker thread. The scheduling component may determine, according to the multiple idle time points, a first frequency at which the idle time point of the target worker thread occurs, and the scheduling component may directly determine the first frequency as the workload index parameter of the target worker thread. The higher the frequency is, the smaller the workload of the target worker thread is.

Optionally, the scheduling component may determine any time within the time interval, such as an intermediate time point or an end time point within the time interval, as the idle time point of the target worker thread. Herein, the end time point within the time interval is the above second start time point. Herein, the reciprocal of the time interval between adjacent idle time points in the target worker thread may be determined as the first frequency of the target worker thread.

Further, the process of performing the computing resource scheduling by using the first frequency as the workload index parameter, is as follows.

In the case where the first frequency is less than a preset minimum frequency, it indicates that the workload of the worker thread is large. Therefore, the resource scheduling strategy generated by the scheduling component is to newly create a worker thread, and allocated the computing resources of the server to the newly created worker thread. In the case where the first frequency is larger than a preset maximum frequency, it indicates that the workload of the worker thread is relatively small. The resource scheduling strategy generated by the scheduling component is to recycle the computing resource allocated to the target worker thread. In addition, similar to the above process, in the case where the resource scheduling strategy is to recycle the computing resource of the worker thread, the kernel may perform the resource scheduling strategy if the target worker thread is in the blocked state, to ensure that the resource scheduling is realized while the task execution is uninterrupted.

In the case where the scheduling component may determine, according to a general workload index parameter of a plurality of worker threads corresponding to the same function instance, whether to perform the resource scheduling, the scheduling component may also determine the general workload index parameter of the plurality of worker threads in the following manner. The following manner may also be understood in combination with the flowchart shown in FIG. 5c.

The scheduling component may first acquire the idle time point of each of plurality of worker threads in the manner shown in FIG. 5b. It is easy to understand that because tasks generated by the function instance are cached in at least one task queue, a plurality of worker threads corresponding to the function instance may acquire the tasks from at least one task queue and execute the tasks. Thus, task execution progresses of the worker threads are different from each other, such that idle time points, computed by the scheduling component, of each of a plurality of worker threads have the chronological sequence in the timing-sequence. The scheduling component may sort the idle time points of at least one worker thread according to the timing-sequence. The scheduling component determines, according to adjacent idle time points in the sorting result, a second frequency at which the idle time point of the plurality of worker threads occurs. Herein, the reciprocal of the time interval between adjacent idle time points in the sorting result may be determined as the second frequency. The scheduling component may further determine a general workload index parameter of the plurality of worker threads according to the second frequency.

In an optional manner, the scheduling component may directly determine the second frequency as the general workload index parameter of the multiple worker threads. In another optional manner, in the case where the plurality of worker threads have 3 or more idle time points in total, that is, a plurality of second frequencies may occur, the scheduling component may also process, such as averaging or taking the median, the plurality of second frequencies, and the scheduling component may take the processing result as the general workload index parameter of the plurality of worker threads.

For example, it is assumed that tasks generated by the AMF network element in a core network of the 5G private network are cached into a task queue, and a worker thread 1 and a worker thread 2 in the server may respectively acquire the tasks generated by the network element. According to the manner shown in FIG. 5c, the scheduling component may compute idle time points, at the time T1 and at the time T3, of the worker thread 1, and idle time points, at the time T2 and at the time T4, of the worker thread 2. The sorting result of the idle time points is T1-T2-T3-T4. The second frequency computed by the scheduling component includes 1/(T2−T1), 1/(T3−T3), and 1/(T4−T3). At this time, optionally, the scheduling component may determine any one of the above second frequencies as the general workload index parameter of the plurality of worker threads. Alternatively, the scheduling component may process, such as averaging or taking the median, the above 3 second frequencies, and determine the processing result as the general workload index parameter of the plurality of worker threads.

Further, the process of performing the computing resource scheduling by using the second frequency as the workload index parameter, is as follows.

In the case where the second frequency is less than a preset minimum frequency, it indicates that the general workload of the multiple worker threads is relatively large. The resource scheduling strategy generated by the scheduling component is to newly create a worker thread, and allocate the computing resources to the newly created worker thread. In the case where the second frequency is larger than a preset maximum frequency, it indicates that the general workload of the multiple worker threads is small. Therefore, the resource scheduling strategy generated by the scheduling component is recycling the computing resource of the worker thread. Optionally, the worker thread whose computing resources are recycled may be any one of a plurality of worker threads corresponding to the same function instance. In addition, in the case where the resource scheduling strategy is to recycle the computing resource of the worker thread, the kernel may recycle, if a certain worker thread of the multiple worker threads is in the blocked state, the computing resources of the worker thread, to ensure that the resource scheduling is realized while the task execution is uninterrupted.

It should be noted that in the above embodiments shown in FIG. 5b and FIG. 5c, the scheduling component may determine, based on the idle time points, the workload index parameter of the worker thread, and further perform the resource scheduling. In addition, the idle time point is acquired by comparing the time interval with a first preset interval. In the case where the first preset interval is a preset number of machine cycles, the setting principle of the number of the machine cycles may also be understood in combination with the following content.

As mentioned in the above description, the number of tasks generated by the function instance is often in burst. In order to cope with the burst, that is, in order to make the worker thread still have enough computing resources to process these tasks if there is a sudden surge in tasks, in practice, a larger number of machine cycles may be set, such that the workload size of the worker thread does not reach a critical point at which the resource scheduling needs to be performed, that is, the computing resources allocated to the worker thread have a certain degree of idleness, thereby enabling of coping with the surge of the tasks.

A variety of data that may be used as workload index parameters are mentioned in the above various embodiments, for example, at least one duration of the worker thread in a blocked state in the embodiment shown in FIG. 1, the time interval in the embodiment shown in FIG. 5a, the first frequency in the embodiment shown in FIG. 5b, the second frequency in the embodiment shown in FIG. 5b, and the like. In practice, in the case where the function instance is the gNB in a 5G private network or a functional network element in a 5G private network, the duration of the worker thread in the blocked state is on an order of microseconds, and the above-mentioned time interval, first frequency, and second frequency are also on an order of microseconds.

In addition, in practice, after a worker thread uses allocated computing resources to process tasks, some intermediate data is cached in the computing resources (such as the memory resources). The cached intermediate data can accelerate the worker thread to process the other tasks generated by the same function instance. In the case where the cached intermediate data is referenced during resource scheduling, the scheduling component needs to perform the corresponding computing process to compute which computing resources should be allocated to the worker thread. The computing process obviously increases the resource scheduling cycle. In addition, in the case where the resource scheduling is performed on the basis of the intermediate data, it is also easy to cause insufficient computing resource scheduling, that is, a part of computing resources will only be allocated to worker threads corresponding to some function instances, which also cannot improve the utilization of the computing resources well.

In the methods provided by the above various embodiments of the present disclosure, the resource scheduling does not refer to the cached intermediate data, such that the computing resources can be allocated to work threads corresponding to different function instances, and the resource scheduling can be performed more sufficiently. In addition, in the methods provided in the various embodiments of the present disclosure, the function instances are usually the gNBs or functional network elements in a 5G private network. Due to characteristics of these function instances, even if resource scheduling is performed without reference to intermediate data, the task execution speed will not be reduced.

According to the above description, in addition to the function instances in the form of software programs, the server is also installed with third-party application programs associated with functions provided by the function instances. Tasks generated by the third-party application programs are also executed by at least one worker thread in the server. Thus, the scheduling component performs the resource scheduling for the worker threads corresponding to the function instances, while the scheduling may also perform the resource scheduling for the worker threads corresponding to the third-party application programs.

Compared with the tasks generated by function instances, the requirements for the execution timeliness and the timing-sequence property of execution of the tasks generated by third-party application programs are not high. Thus, after the scheduling component determines the resource scheduling strategy applicable to the worker threads corresponding to the function instances according to the methods provided by the above various embodiments, it can directly allocate the remaining computing resources of the server to at least one worker thread corresponding to the third-party application programs. Optionally, the remaining computing resources of the server may be evenly allocated to at least one worker thread, or may be selectively allocated to a part of the at least one worker thread.

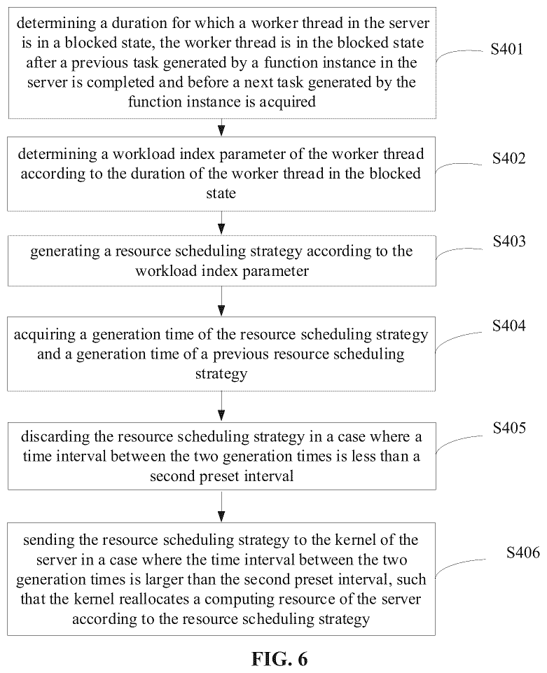

After the scheduling component generates a scheduling strategy by using the above any one workload index parameter, the scheduling component may perform the scheduling according to the scheduling strategy. In order to avoid frequently scheduling computing resources as much as possible, optionally, FIG. 6 is a flowchart of a still thread processing method provided by an embodiment of the present disclosure. As shown in FIG. 6, the method may include the following steps S401-S406.

At the step S401, a duration for which a worker thread in the server is in a blocked state is determined, here, the worker thread is in the blocked state after a previous task generated by a function instance in the server is completed and before a next task generated by the function instance is acquired.

At the step S402, a workload index parameter of the worker thread is determined according to the duration of the worker thread in the blocked state.

At the step S403, a resource scheduling strategy is generated according to the workload index parameter.

The specific implementation processes of steps S401-S403 may refer to the specific description of the relevant steps in the embodiment shown in FIG. 1, which will not be repeated herein.

At the step S404, a generation time of the resource scheduling strategy and a generation time of a previous resource scheduling strategy are acquired.

At the step S405, in a case where a time interval between the two generation times is less than a second preset interval, the resource scheduling strategy is discarded.

At the step S406, in a case where the time interval between the two generation times is larger than the second preset interval, the resource scheduling strategy is sent to the kernel of the server, such that the kernel reallocates a computing resource of the server according to the scheduling strategy.

According to the methods provided by the above various embodiments, the scheduling component may generate a resource scheduling strategy at a time T1. However, the resource scheduling strategy is not directly sent to the kernel of the server. The scheduling component may further acquire a time at which the scheduling component previously generated a resource scheduling strategy, that is, a time T2. The scheduling component compares the two times, and determines, according to the comparison result, how to deal with the resource scheduling strategy generated at the time T1. Here, the resource scheduling strategies generated at the time T1 and at the time T2 act on the same function instance in the server.

Specifically, in the case where the time interval between the time T1 and the time T2 is less than the preset interval, it indicates that the resource scheduling is performed too frequently, and the scheduling component may directly discard the resource scheduling strategy generated at the time T1. At this time, the kernel of the server will not perform the resource scheduling. In the case where the time interval between the time T1 and the time T2 is larger than the preset interval, the scheduling component will send the resource scheduling strategy generated at the time T1 to the kernel, such that the kernel performs the resource scheduling strategy.

Optionally, in the case where the resource scheduling strategies generated at the time T1 and at the time T2 act on different function instances in the server, even if the time interval between the two times is less than the second preset interval, the resource scheduling strategy generated at the time T1 will still be performed by the kernel.

In this embodiment, after generating the resource scheduling strategy at the current time, the scheduling component may also acquire a time at which a resource scheduling strategy was previously generated. In the case where the two scheduling strategies correspond to the same function instance and the time interval between the two generation times is small, the resource scheduling strategy generated at the current time is directly discarded, to avoid frequently scheduling computing resources as much as possible. In addition, for the content that is not described in detail and the technical effect that can be achieved, in this embodiment, reference may be made to the relevant description in the above various embodiments, which will not be repeated herein.

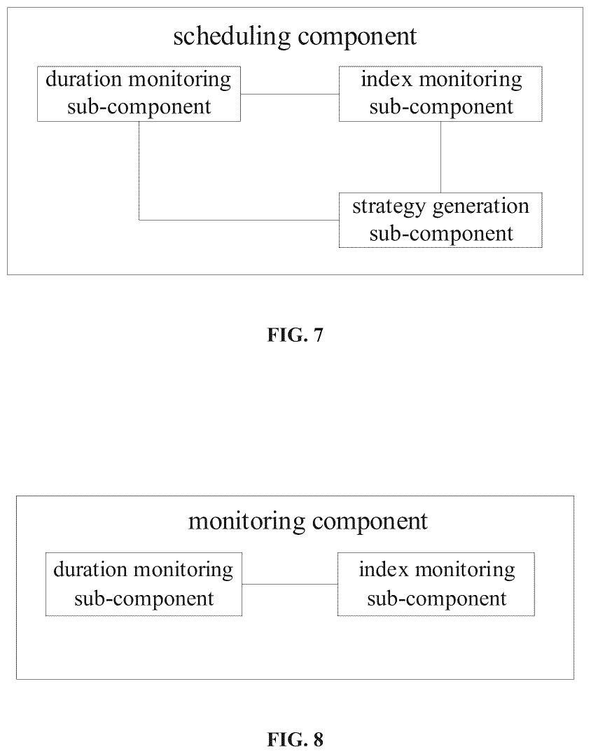

In the embodiments described in FIGS. 1-4 above, a working process of a scheduling component is described by taking the scheduling component as a whole. On this basis, a specific work process of each of sub-components in the scheduling component may also be described. FIG. 7 is a schematic structural diagram of a scheduling component provided by an embodiment of the present disclosure. The component may specifically include a duration monitoring sub-component, an index monitoring sub-component, and a strategy generation sub-component.

The work process of each of sub-components in the scheduling component and interaction processes between sub-components in the scheduling component may be described as follows.

The duration monitoring sub-component determines a duration for which a worker thread in the server is in a blocked state. Here, for the meaning of the blocked state and the determination manner of the blocked state, reference may be made to the relevant description in the embodiment shown in FIG. 1 above. In the case where a function instance corresponds to at least one worker thread, the duration is a duration of each of at least one worker thread in a blocked state. In addition, each worker thread may also be in the blocked state for multiple times, and each blocked state corresponds to one duration.

Each duration of each worker thread may be output to the index monitoring sub-component. Then, the index monitoring sub-component may further determine the workload index parameter of the worker thread according to the duration. Optionally, the workload index parameter may be the relevant data given in the embodiments shown in FIGS. 1 and 5a-5c. The specific determination process of the workload index parameter will not be repeated herein.

After the strategy generation sub-component acquires the workload index parameter output by the index monitoring sub-component and the duration output by the duration monitoring sub-component, the strategy generation sub-component may determine, according to both the workload index parameter and the duration, a resource scheduling strategy, such that the kernel in the server performs the resource scheduling strategy to reallocate the computing resources of the server.

In this embodiment, the duration monitoring sub-component in the scheduling component may determine a duration of a worker thread in a blocked state, then the index monitoring sub-component in the scheduling component may determine a workload index parameter of the worker thread according to the duration, and the strategy generation sub-component in the scheduling component may finally further generate a resource scheduling strategy according to the workload index parameter, such that a kernel of the server performs the resource scheduling strategy to reallocate computing resources of the server.

In the above process, after the worker thread executes one task each time, the strategy generation sub-component generates the resource scheduling strategy, and the kernel further schedules the computing resources of the server. That is, the strategy generation sub-component shortens the cycle of computing resource scheduling to the same order of magnitude as the task execution time length. The scheduling cycle of the computing resources is shortened, and the timely scheduling of the computing resources may also improve the utilization of the computing resources of the server. In addition, the resource scheduling is performed between two tasks, and it will therefore not affect the normal execution, by the worker thread, of the tasks. In addition, for the content that is not described in detail and the technical effect that can be achieved, in this embodiment, reference may be made to the relevant description in the above various embodiments, which will not be repeated herein.

For the scheduling component provided by the above embodiment, there is a one-way data transmission process between various sub-components, and there is no two-way data synchronization process between various sub-components, such that each of the sub-components can quickly acquire the corresponding data, thereby speeding up the generation of the resource scheduling strategy and further shortening the resource scheduling cycle.

Optionally, the server also provides a shared memory. The duration determined by the duration monitoring sub-component and the workload index parameter determined by the index monitoring sub-component may be stored in the shared memory, such that the index monitoring sub-component quickly reads the duration from the shared memory, and the strategy generation sub-component quickly reads the duration from the shared memory and the workload index parameter from the shared memory. The setting of the shared memory may therefore further shorten the resource scheduling cycle.

Optionally, in the embodiment shown in FIG. 6, the process of determining whether the resource scheduling strategy is discarded or sent to the kernel of the server may also be performed by the strategy generation sub-component in the scheduling component.

In addition, for the content that is not described in detail and the technical effect that can be achieved, in this embodiment, reference may also be made to the relevant description in the above various embodiments, which will not be repeated herein.

According to the embodiment shown in FIG. 4 above, the working process of the monitoring component is described specifically, and the monitoring component may be included in the scheduling component. On this basis, the specific working process of the monitoring component may also be described. FIG. 8 is a schematic structural diagram of a monitoring component provided by an embodiment of the present disclosure. The component may specifically include a duration monitoring sub-component and an index monitoring sub-component.

The work process of each of sub-components in the monitoring component and interaction processes between sub-components in the monitoring component may be described as follows.

After a working cycle of the monitoring component is reached, the duration monitoring sub-component determines a duration for which a worker thread in the server is in a blocked state. Here, for the meaning of the blocked state and the determination manner of the blocked state, reference may be made to the relevant description in the embodiment shown in FIG. 1 above. Herein, the length of the working cycle is on an order of microseconds, and the working cycle may specifically be a working cycle of the duration monitoring sub-component.

In the case where a function instance corresponds to at least one worker thread, the duration is a duration of each of at least one worker thread in a blocked state. In addition, each worker thread may also be in the blocked state for multiple times, and each blocked state corresponds to one duration. Each duration of each worker thread may be output to the index monitoring sub-component. Then, the index monitoring sub-component may also further determine the workload index parameter of the worker thread according to the duration. Optionally, the workload index parameter may be the relevant data given in the embodiments shown in FIGS. 1 and 5a-5c. The specific determination process of the workload index parameter will not be repeated herein.

In this embodiment, after a working cycle of the monitoring component is reached, the duration monitoring sub-component in the monitoring component may determine a duration of a worker thread in a blocked state. Then the index monitoring sub-component may determine a workload index parameter of the worker thread according to the duration. In the above process, because the working cycle of the monitoring component is in microseconds and the time length of executing one task, by the worker thread, is also in microseconds, the process of computing, by the monitoring component, the workload index parameter of the worker thread is also in microseconds. A workload monitoring cycle of the worker thread is therefore shortened, that is, the working state of the workload can be monitored in a much timely manner. In addition, for the content that is not described in detail and the technical effect that can be achieved, in this embodiment, reference may also be made to the relevant description in the above various embodiments, which will not be repeated herein.

For the monitoring component provided by the above embodiment, there is a one-way data transmission process between various sub-components, and there is no two-way data synchronization process between various sub-components. Therefore, each of components can quickly acquire the corresponding data, thereby shortening an acquisition cycle of the workload index parameter.

Optionally, a server, in which a monitoring component runs, also provides a shared memory. The duration determined by the duration monitoring sub-component may be stored in the shared memory, such that the index monitoring sub-component quickly reads the duration from the shared memory, to further shorten the acquisition cycle of the workload index parameter.

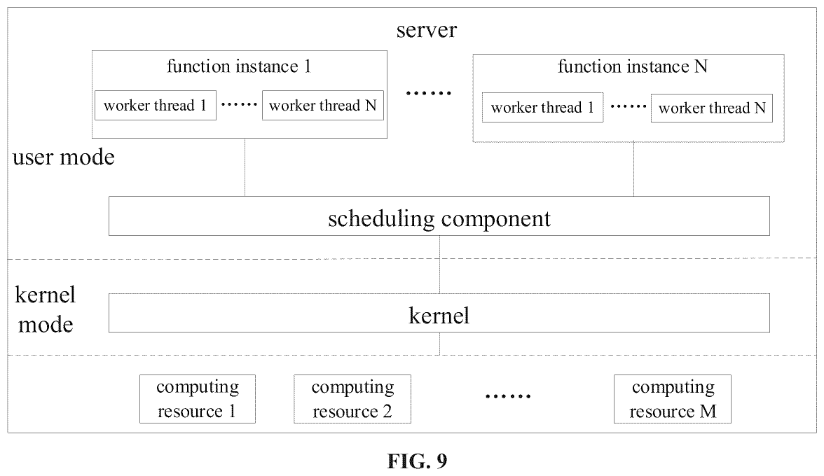

According to the description in the above various embodiments, each of the scheduling component (including the monitoring component) and the function instances may run on the server. FIG. 9 is a schematic structural diagram of a server provided by an embodiment of the present disclosure. The server may include a scheduling component, a kernel, a function instance, and a computing resource.

The scheduling component first determines a duration for which a worker thread in the server is in a blocked state, and determines a workload index parameter of the worker thread according to the duration of the worker thread in the blocked state. Optionally, for a specific process of determining the workload index parameter, reference may be made to the detailed description in the embodiments shown in FIGS. 1 and 5a-5c, which will not be repeated herein. Then, the scheduling component may further generate a resource scheduling strategy according to the workload index parameter. Finally, the kernel in server may acquire the resource scheduling strategy output by the scheduling component, and perform the resource scheduling strategy.

In the above process, the scheduling component is equivalent to a strategy-maker to determine the resource scheduling strategy. The kernel is equivalent to the executor, and is configured for performing the resource scheduling strategy to reallocate the computing resource of the server. Here, each of the scheduling component, the function instance, and the third-party application programs may all run in the operating system of the server. The scheduling component and the function instance may run in the user mode of the operating system. The kernel may acquire, by means of a scheduling class function that is provided internally and runs in the kernel mode of the operating system, the resource scheduling strategy, and may continue to perform the resource scheduling strategy in the kernel mode.

In this embodiment, the scheduling component in the server may determine a duration of a worker thread in a blocked state, determine a workload index parameter of the worker thread according to the duration, and further generate a resource scheduling strategy according to the workload index parameter. The resource scheduling strategy may be acquired and performed by the kernel of the server, to reallocate the computing resources of the server.

In the above process, the worker thread executes one task each time, the scheduling component may compute the workload index parameter of the worker thread, and the kernel further schedules the computing resources of the server. That is, the cycle of computing resource scheduling is shortened to an order of magnitude as same as the task execution time length. The scheduling cycle of the computing resources is shortened, and the timely scheduling of the computing resources may also improve the utilization of the computing resources of the server. In addition, the duration of the blocked state is an intermittent period during which the worker thread executes tasks continuously, such that the resource scheduling is performed between two tasks, thereby not affecting the normal execution of tasks by the worker thread. In addition, for the content that is not described in detail and the technical effect that can be achieved, in this embodiment, reference may also be made to the relevant description in the above embodiments, which will not be repeated herein.

In order to ensure that the task execution is uninterrupted during the resource scheduling, in the case where the resource scheduling strategy is to recycle the computing resource of a worker thread, optionally, the kernel may perform the recycling if the worker thread is in a blocked state.

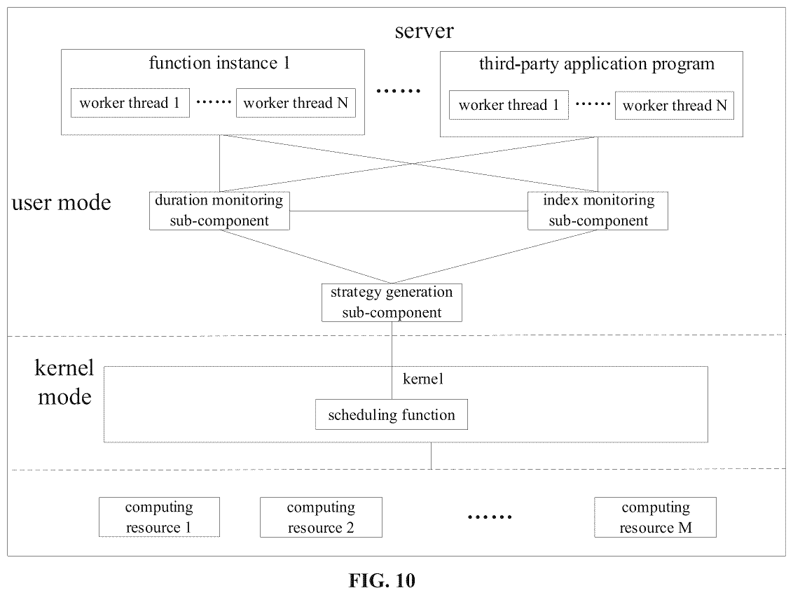

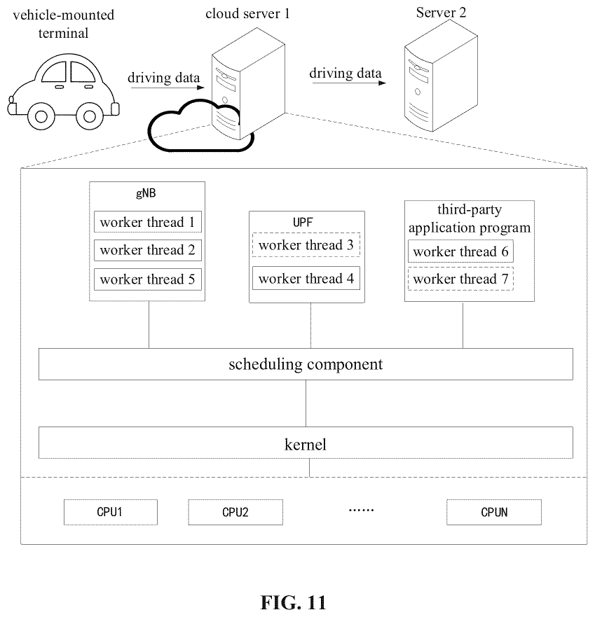

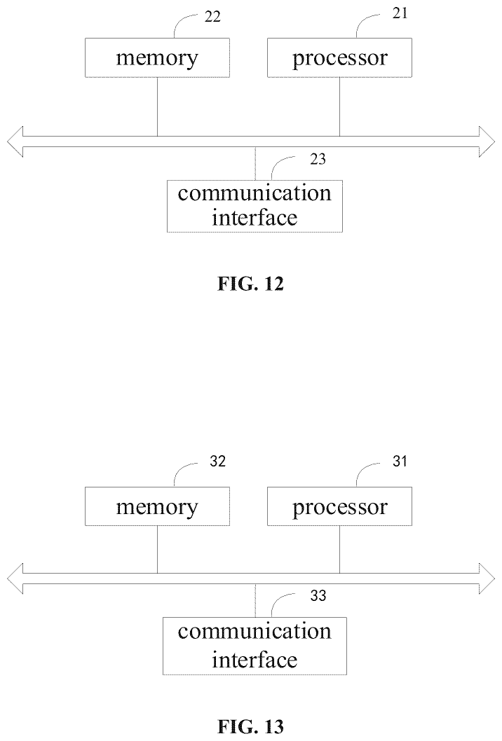

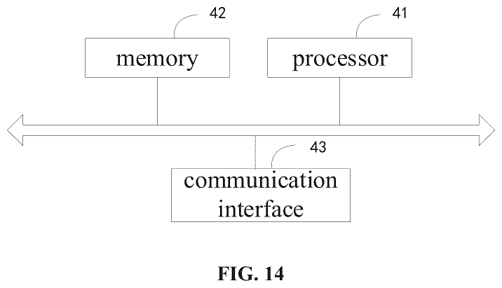

Optionally, the schematic structural diagram of the scheduling component deployed inside the server in this embodiment may be shown in FIG. 7, and the server may also be provided with a third-party application program. FIG. 10 is a schematic structural diagram of another server.

In addition, for the content that is not described in detail and the technical effect that can be achieved, in this embodiment, reference may also be made to the relevant description in the above various embodiments, which will not be repeated herein.

Taking the 5G Internet of Vehicles scenario as an example below, the specific working processes of the thread processing method, the scheduling component, and the server provided by the above various embodiments are described. The below processes may also be understood referring to FIG. 11.

The 5G Internet of Vehicles may include a cloud server 1, a vehicle-mounted terminal, and a server 2. Here, a 5G private network operates in the cloud server 1. That is, the gNB in the private network and various functional network elements in the core network in the private network are, in the form of software, all deployed in the cloud server. The vehicle-mounted terminal can collect driving data, such as a driving speed, a driving direction, of a vehicle. The server 2 is configured for determining an automatic driving strategy applicable to the vehicle according to the driving data.

For a vehicle-mounted terminal that starts the automatic driving function, the driving data collected by the vehicle-mounted terminal usually needs to be transmitted, by the gNB and UPF network element deployed in the form of software, to the server 2. That is, each of the gNB and the UPF network element may generate transmission tasks for the driving data. Specifically, the transmission tasks generated by the gNB are, for example, forwarding the driving data of the vehicle to the UPF network element. The tasks generated by the UPF network element are forwarding the driving data of the vehicle to the server 2. The transmission tasks generated by the gNB and the transmission tasks generated by the UPF network element may be cached into a task queue 1 and a task queue 2, respectively. The cloud server 1 may further create worker threads 1-4. Here, the worker threads 1 and 2 are configured for executing the transmission tasks in the task queue 1, and the worker threads 3 and 4 are configured for executing the transmission tasks in the task queue 2. Here, the computing resources allocated to each worker thread may be considered as computing resources of one kernel in the multi-core cloud server 1.

Taking the worker threads 1 and 2 corresponding to the gNB as an example, the process of the resource scheduling is described as follows.

In the case where the worker thread 1 continuously executes the transmission tasks in the task queue 1, the scheduling component in the server 1 may acquire at least one duration for which the worker thread 1 is in the blocked state at least once, and then determine the workload index parameter of the worker thread 1 on the basis of the at least one duration. Here, for each of the specific content of the index parameter and the determination manner of the index parameter, reference may be made to the description in the above relevant embodiments, which will not be repeated herein. Similarly, the scheduling component may also acquire the workload index parameter of the worker thread 2.

Further, in one manner, in the case where the workload index parameter indicates that the workload of worker thread 1 and/or the workload of the worker thread 2 is/are relatively large, the resource scheduling strategy generated by the scheduling component is to create a worker thread, that is, to create a worker thread 5 for the gNB, and the worker thread 5 is further configured for executing the tasks in the task queue 1. On the contrary, in the case where the scheduling component determines that the workload of the worker thread 1 is relatively small, the resource scheduling strategy generated by the scheduling component is to recycle the computing resources of the worker thread 1, and the computing resources of the worker thread 1 may be allocated to other worker threads in the server.

In another manner, as shown in FIG. 5c, the scheduling component may determine, according to the workload index parameter of each of the worker thread 1 and the worker thread 2, an index parameter indicating a general workload size of the worker thread 1 and the worker thread 2, and then generate a resource scheduling strategy according to the index parameter.

For the worker threads 3 and 4 corresponding to the UPF network element, the resource scheduling may also be performed in the above manner. The resource scheduling strategy generated by the scheduling component may be to recycle the computing resources of the worker thread 3.

After the scheduling component generates a resource scheduling strategy, the strategy is sent to the kernel by means of the scheduling class function in the kernel of the server, such that the kernel performs the resource scheduling strategy. The above resource scheduling strategies are all generated in microseconds and are generated between two tasks, thereby not affect the normal execution of the transmission tasks.

In addition, because the function instance corresponding to the worker threads 1 and 2 is different from the function instance corresponding to the worker threads 3 and 4, and time lengths of executing, by a plurality of worker threads, tasks are different from each other, the scheduling component may generate resource scheduling strategies, for the gNB and the UPF network element, at different times respectively. For example, the scheduling component generates a resource scheduling strategy, that is, newly creating the worker thread 5, for the gNB at the time T1, and the scheduling component generates a resource scheduling strategy, that is, recycling the worker thread 3, for the UPF network element at the time T2.

Optionally, in order to avoid frequent resource scheduling as far as possible, after the scheduling component generates a resource scheduling strategy at the time T1, the scheduling component may also acquire the time at which the resource scheduling strategy for the gNB was previously generated. In the case where the time interval between the two times is less than the second preset interval, the resource scheduling strategy generated at the time T1 is discarded.

In the case where resource scheduling strategies are generated for different function instances, it is not necessary to consider the time interval between the generation time of the previous resource scheduling strategy and the generation time of the next resource scheduling strategy.

Optionally, the cloud server 1 may also be installed with a further third-party application program. After the kernel of the cloud server 1 newly creates a worker thread 5 and allocates computing resources to the worker thread 5, the kernel may also allocate the remaining computing resources in the cloud server 1 to the third-party application program. Similarly, after the kernel of the cloud server 1 recycles the computing resources of the worker thread 3, the kernel may also allocate the remaining computing resources in the cloud server 1 to a worker thread corresponding to the third-party application program. For example, on the basis of the original worker thread 6, a worker thread 7 is newly created.

In addition, various embodiments provided by this solution may also be applied in any scenario, such as live broadcast, telemedicine, online finance, realized by means of a 5G communication network.

In a possible design, the thread processing methods provided by the above various embodiments may be applied to an electronic device. As shown in FIG. 12, the electronic device may include a processor 21 and a memory 22. Here, the memory 22 is configured for storing a program that supports the electronic device to perform any one of the thread processing methods provided in the embodiments shown in FIGS. 1-2 and FIGS. 5a-6. The processor 21 is configured for executing the program stored in the memory 22.

The program includes one or more computer instructions. Here, the one or more computer instructions, when executed by the processor 21, can implement the following steps of: determining a duration for which a worker thread in the server is in a blocked state, here, the worker thread is in the blocked state after a previous task generated by a function instance in the server is completed and before a next task generated by the function instance is acquired; determining a workload index parameter of the worker thread according to the duration of the worker thread in the blocked state; and generating a resource scheduling strategy according to the workload index parameter, such that a kernel of the server reallocates a computing resource of the server according to the scheduling strategy.

Optionally, the processor 21 is further configured for performing all or part of steps in the embodiments shown in FIGS. 1-2 and FIGS. 5a-6 above.

Here, the structure of the electronic device may also include a communication interface 23 for the electronic device to communicate with other devices or communication systems.

In addition, an embodiment of the present disclosure provides a computer storage medium. The computer storage medium is configured for storing the computer software instructions used by the above electronic device, and the computer storage medium includes programs that are configured for performing the thread processing methods of the method embodiments shown in FIGS. 1-2 and FIGS. 5a-6.

In a possible design, the thread processing methods provided by the above various embodiments may be applied to another electronic device. As shown in FIG. 13, the electronic device may include a processor 21 and a memory 22. Here, the memory 32 is configured for storing a program that supports the electronic device to perform any one of the thread processing methods provided in the embodiments shown in FIG. 3 and FIGS. 5a-6. The processor 31 is configured for executing the program stored in the memory 32.

The program includes one or more computer instructions. Here, the one or more computer instructions, when executed by the processor 31, can implement the following steps of: determining a duration for which a worker thread in the cloud server is in a blocked state, here, the worker thread is in the blocked state after a previous task generated by a function instance in the server is completed and before a next task generated by the function instance is acquired; determining a workload index parameter of the worker thread according to the duration of the worker thread in the blocked state, here, the function instance includes a functional network element in a 5G private network; and generating a resource scheduling strategy according to the workload index parameter, such that a kernel of the server reallocates a computing resource of the server according to the scheduling strategy.

Optionally, the processor 31 is further configured for performing all or part of steps in the embodiments shown in FIG. 3 and FIGS. 5a-6 above.

Here, the structure of the electronic device may further include a communication interface 33 for the electronic device to communicate with other devices or communication systems.

In addition, the embodiment of the present disclosure provides a computer storage medium. The computer storage medium is configured for storing the computer software instructions used by the above electronic device, and the computer storage medium includes programs that are configured for performing the thread processing methods of the method embodiments shown in FIG. 3 and FIGS. 5a-6.

In a possible design, the thread processing methods provided by the above various embodiments may be applied to yet another electronic device. As shown in FIG. 14, the electronic device may include a processor 41 and a memory 42. Herein, the memory 42 is configured for storing a program that supports the electronic device to perform any one of the thread processing methods provided in the embodiments shown in FIG. 4 and FIGS. 5a-5c. The processor 41 is configured for executing the program stored in the memory 42.

The program includes one or more computer instructions. Here, the one or more computer instructions, when executed by the processor 41, can implement the following steps of: determining a duration for which a worker thread in the server is in a blocked state when a working cycle of the monitoring component is reached, here, the worker thread is in the blocked state after a previous task generated by a function instance in the server is completed and before a next task generated by the function instance is acquired; and determining a workload index parameter of the worker thread according to the duration of the worker thread in the blocked state, here, a length of the working cycle is on an order of magnitude of microseconds.

Optionally, the processor 41 is further configured for performing all or part of steps in the embodiments shown in FIG. 4 and FIGS. 5a-5c above.

Herein, the structure of the electronic device may also include a communication interface 43 for the electronic device to communicate with other devices or communication systems.

In addition, the embodiment of the present disclosure provides a computer storage medium. The computer storage medium is configured for storing the computer software instructions used by the above electronic device, and the computer storage medium includes programs that are configured for performing the thread processing methods of the method embodiments shown in FIG. 4 and FIGS. 5a-5c.

Finally, it should be noted that: the above embodiments are only used to describe, rather than to limit, the technical solutions of the present disclosure; although the present disclosure has been described in detail with reference to the preceding embodiments, those of ordinary skill in the art should understand that they may still modify technical solutions recorded in the above various embodiments or perform equivalent replacements for a part of the technical features in the technical solutions; however, these modifications or replacements do not make the essence of the corresponding technical solutions deviate from the spirit and scope of the technical solutions of the various embodiments of the present disclosure.

What is claimed is:

1. A thread processing method, applied to a scheduling component in a server, the method comprising:
determining a duration for which a worker thread in the server is in a blocked state, wherein the worker thread is in the blocked state after a previous task generated by a function instance in the server is completed and before a next task generated by the function instance is acquired;
determining a workload index parameter of the worker thread according to the duration of the worker thread in the blocked state; and
generating a resource scheduling strategy according to the workload index parameter, such that a kernel of the server reallocates a computing resource of the server according to the resource scheduling strategy.

2. The method of claim 1, wherein the scheduling component is provided with a delay function, and
the determining the duration for which the worker thread in the server is in the blocked state, comprises:
determining, when a working cycle of the scheduling component is reached, whether the delay function is executed by the worker thread, wherein a length of the working cycle is on an order of magnitude of microseconds;
determining, in a case where the worker thread executes the delay function after executing the previous task, a start time and an end time at which the delay function is executed; and
determining a time period composed of the start time and the end time as the duration of the blocked state.

3. The method of claim 1, wherein the server is deployed with at least one function instance, and the worker thread is configured for executing a task generated by any one of the at least one function instance, wherein the working thread is plural in number.

4. The method of claim 3, wherein the duration of the blocked state is composed of a start time point and an end time point, and
the determining the workload index parameter of the worker thread according to the duration of the worker thread in the blocked state, comprises:
determining a first duration and a second duration of two adjacent blocked states for a target worker thread, wherein the target worker thread is any one of a plurality of worker threads;
determining a time interval between a first start time point in the first duration and a second start time point in the second duration; and
determining a workload index parameter of the target worker thread according to the time interval.

5. The method of claim 4, wherein the determining the workload index parameter of the target worker thread according to the time interval, comprises:
determining an idle time point, within the time interval, of the target worker thread in a case where the time interval is less than a first preset interval;
determining, according to a plurality of adjacent idle time points of the target worker thread, a first frequency at which the idle time points of the target worker thread occur; and
determining the first frequency as the workload index parameter of the target worker thread.

6. The method of claim 5, further comprising:
sorting idle time points of each of the plurality of worker threads according to timing-sequence;
determining, according to adjacent idle time points in a sorting result, a second frequency at which the idle time points of the plurality of worker threads occur; and
determining a workload index parameter of the plurality of worker threads according to the second frequency.

7. The method of claim 5, wherein the first frequency and/or the second frequency are comprised in a target frequency, and
the generating the resource scheduling strategy according to the workload index parameter, comprises:
determining, in a case where the target frequency is less than a preset minimum frequency, that the resource scheduling strategy is to newly create a worker thread and allocate the computing resource of the server to the newly created worker thread; and
determining, in a case where the target frequency is larger than a preset maximum frequency, that the resource scheduling strategy is to recycle the computing resource allocated to the worker thread.

8. The method of claim 6, wherein the first frequency and/or the second frequency are comprised in a target frequency, and
the generating the resource scheduling strategy according to the workload index parameter, comprises:
determining, in a case where the target frequency is less than a preset minimum frequency, that the resource scheduling strategy is to newly create a worker thread and allocate the computing resource of the server to the newly created worker thread; and
determining, in a case where the target frequency is larger than a preset maximum frequency, that the resource scheduling strategy is to recycle the computing resource allocated to the worker thread.

9. The method of claim 1, further comprising:
acquiring a generation time of the resource scheduling strategy and a generation time of a previous resource scheduling strategy; and
discarding the resource scheduling strategy in a case where a time interval between the two generation times is less than a second preset interval, wherein the resource scheduling strategy and the previous resource scheduling strategy correspond to a same function instance; and
the generating the resource scheduling strategy according to the workload index parameter, such that the kernel of the server reallocates the computing resource of the server according to the resource scheduling strategy, comprises:
sending the resource scheduling strategy to the kernel in a case where the time interval between the two generation times is larger than the second preset interval.

10. The method of claim 1, wherein the server is installed with a third-party application program, and the generating the resource scheduling strategy according to the workload index parameter, comprises:
determining, according to the workload index parameter, that the resource scheduling strategy comprises allocating a target computing resource of the server to a worker thread corresponding to the function instance; and
determining that the resource scheduling strategy further comprises allocating a remaining computing resource of the server to a worker thread corresponding to the third-party application program.

11. A thread processing method, applied to a cloud server in which a 5G private network runs, the method comprising:
determining a duration for which a worker thread in the cloud server is in a blocked state, wherein the worker thread is in the blocked state after a previous task generated by a function instance in the server is completed and before a next task generated by the function instance is acquired;
determining a workload index parameter of the worker thread according to the duration of the worker thread in the blocked state, wherein the function instance comprises a functional network element in the 5G private network; and
generating a resource scheduling strategy according to the workload index parameter, such that a kernel of the server reallocates a computing resource of the server according to the resource scheduling strategy.

12. The method of claim 11, wherein the cloud server is provided with a delay function, and
the determining the duration for which the worker thread in the cloud server is in the blocked state, comprises:
determining, when a resource scheduling cycle of the cloud server is reached, whether the delay function is executed by the worker thread, wherein a length of the resource scheduling cycle is on an order of magnitude of microseconds;
determining, in a case where the worker thread executes the delay function after executing the previous task, a start time and an end time at which the delay function is executed; and
determining a time period composed of the start time and the end time as the duration of the blocked state.

13. The method of claim 11, wherein, the functional network element comprises a functional network element in a core network comprised in the 5G private network and/or an access network element in an access network comprised in the 5G private network.

14. A thread processing method, applied to a monitoring component in a server, the method comprising:
determining, when a working cycle of the monitoring component is reached, a duration for which a worker thread in the server is in a blocked state, wherein the worker thread is in the blocked state after a previous task generated by a function instance in the server is completed and before a next task generated by the function instance is acquired; and
determining a workload index parameter of the worker thread according to the duration of the worker thread in the blocked state, wherein a length of the working cycle is on an order of magnitude of microseconds.

15. A scheduling component, running on a server, the scheduling component comprising a duration monitoring sub-component, an index monitoring sub-component, and a strategy generation sub-component, wherein
the duration monitoring sub-component is configured for determining a duration for which a worker thread in the server is in a blocked state, wherein the worker thread is in the blocked state after a previous task generated by a function instance in the server is completed and before a next task generated by the function instance is acquired;
the index monitoring sub-component is configured for determining a workload index parameter of the worker thread according to the duration of the worker thread in the blocked state; and
the strategy generation sub-component is configured for generating a resource scheduling strategy according to the workload index parameter, such that a kernel of the server reallocates a computing resource of the server according to the resource scheduling strategy.

16. The scheduling component of claim 15, wherein the server provides a shared memory, and
the duration monitoring sub-component is configured for writing the duration of the blocked state into the shared memory;
the index monitoring sub-component is configured for reading the duration of the blocked state from the shared memory, and writing the workload index parameter into the shared memory; and
the strategy generation sub-component is configured for reading the workload index parameter from the shared memory.

17. A monitoring component, running on a server, the monitoring component comprising a duration monitoring sub-component and an index monitoring sub-component, wherein
the duration monitoring sub-component is configured for determining, when a working cycle of the monitoring component is reached, a duration for which a worker thread in the server is in a blocked state, wherein the worker thread is in the blocked state after a previous task generated by a function instance in the server is completed and before a next task generated by the function instance is acquired; and
the index monitoring sub-component is configured for determining a workload index parameter of the worker thread according to the duration of the worker thread in the blocked state, wherein a length of the working cycle is on an order of magnitude of microseconds.

18. A server, comprising a scheduling component, a kernel, a function instance, and a computing resource, wherein
the scheduling component is configured for: determining a duration for which a worker thread in the server is in a blocked state, wherein the worker thread is in the blocked state after a previous task generated by the function instance in the server is completed and before a next task generated by the function instance is acquired; determining a workload index parameter of the worker thread according to the duration of the worker thread in the blocked state; and generating a resource scheduling strategy according to the workload index parameter; and
the kernel is configured for reallocating the computing resource of the server according to the resource scheduling strategy.

19. The server of claim 16, wherein the resource scheduling strategy comprises recycling the computing resource allocated to the worker thread, and
the kernel is configured for: acquiring the resource scheduling strategy by using a scheduling class function provided in the kernel; and recycling, in a case where the worker thread is in the blocked state, the computing resource allocated to the worker thread.

20. A non-transitory machine-readable storage medium, wherein executable codes are stored on the non-transitory machine-readable storage medium, and the executable codes, when executed by a processor of an electronic device, cause the processor to:
determining a duration for which a worker thread in the server is in a blocked state, wherein the worker thread is in the blocked state after a previous task generated by a function instance in the server is completed and before a next task generated by the function instance is acquired;
determining a workload index parameter of the worker thread according to the duration of the worker thread in the blocked state; and
generating a resource scheduling strategy according to the workload index parameter, such that a kernel of the server reallocates a computing resource of the server according to the resource scheduling strategy.
